(19) United States
(12) Patent Application Publication
(10) Pub. No.: US 2015/0215849 A1
(43) Pub. Date: Jul. 30, 2015

(54) SYSTEMS AND METHODS FOR ACCELERATED NETWORK ACQUISITION

(71) Applicant: QUALCOMM Incorporated, San Diego, CA (US)

(72) Inventors: Harinath Reddy Patel, Hyderabad (IN); Mungal Singh Dhanda, Slough (GB); Mahender Reddy Akkapally, Hyderabad (IN); Simon Walke, Basingstoke (GB); Nitin Sachdeva, Hyderabad (IN)

(73) Assignee: QUALCOMM Incorporated, San Diego, CA (US)

(21) Appl. No.: 14/163,829

(22) Filed: Jan. 24, 2014

(51) Int. Cl. H04W 48/16

(52) U.S. Cl. CPC H04W 48/16

(57) ABSTRACT

A method for wireless communication by a wireless communication device is described. The method includes searching for service on a public land mobile network (PLMN). The method also includes discovering a cell of a requested PLMN. The method further includes determining that cell selection criteria for the cell is not met. The method additionally includes adding the cell to a monitored list. The method also includes monitoring cells in the monitored list more frequently than cells not in the monitored list. Other aspects, embodiments, and features are also claimed and described.

### TECHNICAL FIELD

The technology discussed below relates generally to communication systems, and more specifically, to systems and methods for accelerated network acquisition. Implementation of embodiments can be used to enable efficient power consumption and improved system acquisition.

### BACKGROUND

Wireless communication systems have become an important means by which many people worldwide have come to communicate. A wireless communication system may provide communication for a number of wireless communication devices, each of which may be serviced by a base station.

New wireless communication devices are continuously being released to the public. These new wireless communication devices boast more features and increased reliability. These wireless communication devices may be capable of performing voice and data operations.

One concern for users of wireless communication devices is the time it takes to connect to a network. For example, when the wireless communication device has poor coverage. A long delay in acquiring a network may extend the time that a wireless communication device is out of service, in limited service or roaming.

### SUMMARY OF SOME EXAMPLE EMBODIMENTS

Embodiments of the present invention address the above issues as well as others. Indeed, embodiments of the present invention provide power efficient devices, systems, and methods that can alleviate time delays. Doing so can not only utilize power resources efficiently but can aid in minimizing delays associated with network communications.

A method for wireless communication by a wireless communication device is described. The method includes searching for service on a public land mobile network (PLMN). The method also includes discovering a cell of a requested PLMN. The method further includes determining that cell selection criteria for the cell is not met. The method additionally includes adding the cell to a monitored list. The method also includes monitoring cells in the monitored list more frequently than cells not in the monitored list.

The wireless communication device may be out-of-service (OOS), in limited service or roaming. Monitoring cells in the monitored list more frequently than cells not in the monitored list may include monitoring the cells in the monitored list upon waking up and decoding a page.

The method may also include monitoring cells in the monitored list at regular intervals. The method may further include repeatedly monitoring cells in the monitored list at a faster rate than cells not in the monitored list. The method may additionally include camping on a cell when a cell is found that meets the cell selection criteria.

The requested PLMN may be one of a selected PLMN, a registered PLMN or an equivalent PLMN. The selected PLMN or the registered PLMN may be a home PLMN for the wireless communication device. The equivalent PLMN may be treated as a home PLMN for the wireless communication device.

Determining that cell selection criteria for the cell is not met may include evaluating a C1 parameter for the cell. If the C1 parameter is greater than zero, then the cell selection criteria is met. If the C1 parameter is less than or equal to zero, then the cell selection criteria is not met. The C1 parameter may be determined based on received signal levels for the cell, a minimum received signal level at the wireless communication device required for access to the cell, a maximum transmission power level the wireless communication device may use when accessing the cell and a maximum radio frequency output power of the wireless communication device.

An apparatus for wireless communication is also described. The apparatus includes a processor, memory in electronic communication with the processor and instructions stored in the memory. The instructions are executable by the processor to search for service on a public land mobile network (PLMN). The instructions are also executable to discover a cell of a requested PLMN. The instructions are further executable to determine that cell selection criteria for the cell is not met. The instructions are additionally executable to add the cell to a monitored list. The instructions are also executable to monitor cells in the monitored list more frequently than cells not in the monitored list.

A wireless device is also described. The wireless device includes means for searching for service on a public land mobile network (PLMN). The wireless device also includes means for discovering a cell of a requested PLMN. The wireless device further includes means for determining that cell selection criteria for the cell is not met. The wireless device additionally includes means for adding the cell to a monitored list. The wireless device also includes means for monitoring cells in the monitored list more frequently than cells not in the monitored list.

A computer-program product for wireless communications is also described. The computer-program product includes a non-transitory computer-readable medium having instructions thereon. The instructions include code for causing a wireless communication device to search for service on a public land mobile network (PLMN). The instructions also include code for causing the wireless communication device to discover a cell of a requested PLMN. The instructions further include code for causing the wireless communication device to determine that cell selection criteria for the cell is not met. The instructions additionally include code for causing the wireless communication device to add the cell to a monitored list. The instructions also include code for causing the wireless communication device to monitor cells in the monitored list more frequently than cells not in the monitored list.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments, it should be understood that such exemplary embodiments can be implemented in various devices, systems, and methods.

### BRIEF DESCRIPTION OF THE DRAWINGS

FIG. 1 is a block diagram illustrating a wireless communication system for performing accelerated network acquisition according to embodiments of the present invention;

FIG. 2 is a flow diagram of a method for accelerated network acquisition according to some embodiments;

FIG. 3 is a block diagram illustrating a radio network operating according to embodiments of the present invention;

FIG. 4 is a block diagram illustrating an embodiment of a wireless communication system for performing accelerated network acquisition in a Global System for Mobile (GSM) network;

FIG. 5 is a flow diagram of a method for one embodiment of accelerated network acquisition in a GSM network;

FIG. 6 is a flow diagram of a method for another embodiment of accelerated network acquisition in a GSM network;

FIG. 7 illustrates certain components that may be included within a wireless communication device according to some embodiments of the present invention; and

FIG. 8 illustrates certain components that may be included within a base station according to some embodiments of the present invention.

### DETAILED DESCRIPTION

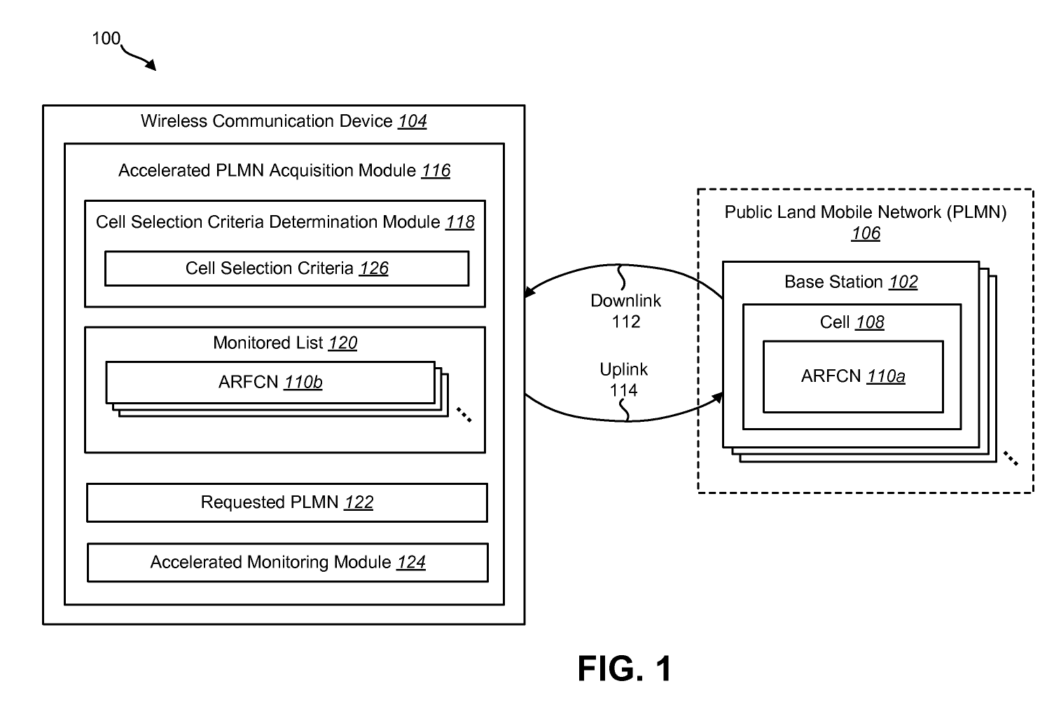

FIG. 1 is a block diagram illustrating a wireless communication system 100 for performing accelerated network acquisition according to embodiments of the present invention. Wireless communication systems 100 are widely deployed to provide various types of communication content such as voice, data, and so on. A wireless device may be a base station 102 or a wireless communication device 104. The wireless communication device 104 may be configured for accelerated network acquisition. For example, the wireless communication device 104 may be configured to dynamically adjust a list of cells 108 that are monitored to discover a requested public land mobile networks (PLMNs) 122.

A base station 102 is a station that may communicate with one or more wireless communication devices 104. A base station 102 may also be referred to as, and may include some or all of the functionality of an access point, a broadcast transmitter, a NodeB, an evolved NodeB, a base transceiver station, etc. The term “base station” will be used herein. Each base station 102 may provide communication coverage for a particular geographic area. A base station 102 may provide communication coverage for one or more wireless communication devices 104. The term “cell” can refer to a base station 102, the coverage area of the base station 102 and/or communication channels between the base station 102 and wireless communication device 104 depending on the context in which the term is used. A single base station 102 may provide one or more cells 108.

Communications in a wireless system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink 114 and downlink 112 transmissions are on the same frequency region so that the reciprocity principle allows the estimation of the downlink 112 channel from the uplink 114 channel. This enables a transmitting wireless device (e.g., base station 102 or wireless communication device 104) to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, 3^{rd} Generation Partnership Project (3GPP) Long Term Evolution (LTE) systems, and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems, and mobile devices.

In 3GPP Long Term Evolution (LTE), a wireless communication device 104 may be referred to as a “user equipment” (UE). In 3GPP Global System for Mobile Communications (GSM), a wireless communication device 104 may be referred to as a “mobile station” (MS). A wireless communication device 104 may also be referred to as, and may include some or all of the functionality of, a terminal, an access terminal, a subscriber unit, a station, etc. A wireless communication device 104 may be a cellular phone, a personal digital assistant (PDA), a wireless device, a wireless modem, a handheld device, a laptop computer, a Session Initiation Protocol (SIP) phone, a wireless local loop (WLL) station, etc.

A wireless communication device 104 may communicate with zero, one or multiple base stations 102 on the downlink 112 and/or uplink 114 at any given moment. The downlink 112 (or forward link) refers to the communication link from a base station 102 to a wireless communication device 104, and the uplink 114 (or reverse link) refers to the communication link from a wireless communication device 104 to a base station 102.

When a wireless communication device 104 is experiencing poor coverage, the wireless communication device 104 may be out of service, may have limited service or may be roaming. During poor coverage conditions, the wireless communication device 104 may search for service on a public land mobile network (PLMN) 106. A PLMN 106 may be identified by a mobile country code (MCC) and a mobile network code (MNC). A wireless communication device 104 may access a PLMN 106 via a cell 108 provided by a base station 102.

In one embodiment, a requested PLMN 122 may include a selected/registered PLMN or an equivalent PLMN. A selected/registered PLMN may be a home PLMN for the wireless communication device 104. A selected PLMN may be a PLMN that has been selected by the non-access stratum (NAS). A registered PLMN may be a PLMN on which a location registration has occurred.

An equivalent PLMN may be a PLMN that is treated as the home PLMN of the wireless communication device 104. The wireless communication device 104 may reselect to an equivalent PLMN and enjoy the same benefits as the selected/registered PLMN. There are two kinds of equivalent PLMN lists. The equivalent PLMN list stored on the subscriber identity module (SIM) is called the Equivalent Home PLMN (EHPLMN) list. Any of the PLMNs listed in the EHPLMN list provide the same benefits as the home PLMN (HPLMN). The other kind of equivalent PLMN list is received from the registered PLMN and this is called the Equivalent PLMN (EPLMN).

The wireless communication device 104 may perform a power scan on all the supported GSM frequencies to discover cells 108. The wireless communication device 104 may decode a PLMN ID on each frequency with a good power level by decoding a system information message. The system information message may be a system information type 3 (SI3) message or a system information type 4 (SI4) message. The system information message may include the PLMN ID. The wireless communication device 104 may evaluate whether the PLMN 106 of a discovered cell 108 matches the requested PLMN 122. In other words, the wireless communication device 104 may determine whether the PLMN 106 of a discovered cell 108 is a selected PLMN or an equivalent PLMN for the wireless communication device 104.

A cell selection criteria determination module 118 may evaluate cell selection criteria 126 for the cell 108. The cell selection criteria 126 may indicate whether a cell 108 is strong enough for the wireless communication device 104 to camp on. For a GSM network, the cell selection criteria 126 may be based on a C1 parameter that is determined for the cell 108. The C1 parameter may be determined by the cell selection criteria determination module 118 based on received power measured by the wireless communication device 104. In one embodiment, the C1 parameter may be determined according to Equation (1) below. For a CDMA or W-CDMA network, the cell selection criteria 126 may be based on a QUAL parameter.

The cell selection criteria determination module 118 may evaluate the C1 parameter for a discovered cell 108. If the C1 parameter is greater than zero, then the cell selection criteria 126 is met. If the C1 parameter is less than or equal to zero, then the cell selection criteria 126 is not met. In one embodiment, the C1 parameter may have a threshold of 0. If the C1 parameter is greater than 0, then a cell is suitable to camp on.

If the PLMN 106 of a discovered cell 108 matches the requested PLMN 122 of the wireless communication device 104, and if that cell 108 meets cell selection criteria 126 (e.g., C1>0), then the wireless communication device 104 may camp on that cell 108. If the cell selection criteria 126 is not met (e.g., C1=<0), then the wireless communication device 104 will not camp on that cell 108 even though the PLMN 106 of the cell 108 matches a requested PLMN 122. The wireless communication device 104 may remain in the same service state as before (e.g., out of service, limited service or roaming) until the wireless communication device 104 performs another search for service.

While the wireless communication device 104 waits to perform another search for service, one or more cells 108 that did not meet the cell selection criteria 126 may subsequently meet the cell selection criteria 126 (e.g., C1>0). Therefore, the wireless communication device 104 may miss an opportunity to camp on these cells 108. This may delay acquiring service on a requested PLMN 122 (e.g., selected PLMN or an equivalent PLMN).

A wireless communication device 104 may perform a search procedure while out of service (OOS). The wireless communication device 104 may find a cell 108 in a requested PLMN 122. If the cell selection criteria 126 of the cell 108 is not met (e.g., C1=<0), the wireless communication device 104 may add cell 108 to a monitored list 120. In one configuration, the wireless communication device 104 may add the absolute radio-frequency channel number (ARFCN) 110b of the cell 108 to a monitored list 120. An ARFCN 110 defines a pair of radio frequency (RF) channel frequencies for the downlink 112 and uplink 114 associated with a particular cell 108. Therefore, an ARFCN 110 may identify a cell 108. Upon adding the cell 108 to the monitored list 120, the wireless communication device 104 may continue the search procedure.

The wireless communication device 104 may remain in OOS if the wireless communication device 104 cannot find any requested PLMN 122. A new service acquisition (e.g., search procedure) may not be attempted until a re-try timer expires. In one embodiment, the re-try timer may have a time period of 30 seconds.

If the monitored list 120 has one or more ARFCNs 110b (e.g., the monitored list 120 is not empty), then an accelerated monitoring module 124 may keep monitoring those cells 108 in the monitored list 120 more frequently than cells 108 not in the monitored list 120. In one embodiment, the accelerated monitoring module 124 may monitor the frequencies associated with the ARFCNs 110b included in the monitored list 120.

The accelerated monitoring module 124 may repeatedly monitor cells in the monitored list 120 at a faster rate than cells not in the monitored list. For example, the accelerated monitoring module 124 may monitor the ARFCNs 110b in the monitored list 120 at regular intervals, but at a faster rate than attempts to search a larger set of frequencies for service. In one embodiment, the faster rates may be from 2 to 5 seconds.

When a wireless communication device 104 performs a search procedure while in limited service or roaming, the wireless communication device 104 may maintain a monitored list 120, as described for the OOS case. However, while in limited service or roaming, the accelerated monitoring module 124 may monitor the cells 108 in the monitored list 120 after the wireless communication device 104 wakes up and decodes a page.

If the accelerated monitoring module 124 finds a cell 108 that meets the cell selection criteria 126 (e.g., C1>0), then the wireless communication device 104 may camp on the cell 108. The wireless communication device 404 may perform registration, if necessary, with the network and enter a normal service state.

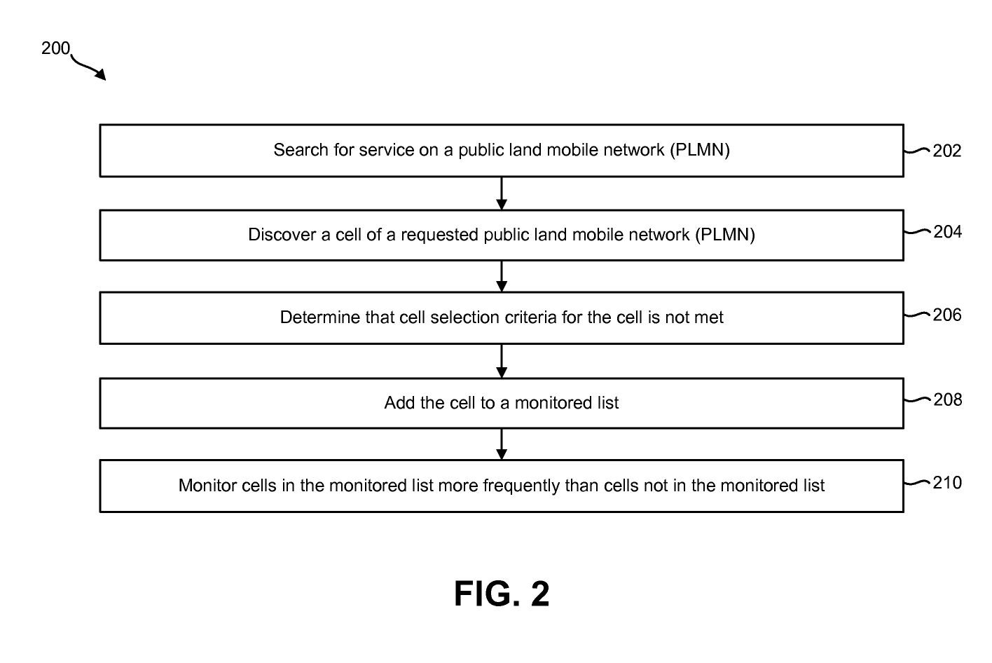

FIG. 2 is a flow diagram of a method 200 for accelerated network acquisition according to some embodiments. The method 200 may be performed by a wireless communication device 104. In one configuration, the wireless communication device 104 may include an accelerated public land mobile network (PLMN) acquisition module 116. The wireless communication device 104 may search 202 for service on a PLMN 106. For example, the wireless communication device 104 may be experiencing poor coverage. The wireless communication device 104 may be out of service, may have limited service or may be roaming.

The wireless communication device 104 may perform a power scan on all the supported GSM frequencies to discover cells 108. For example, while out of service, in limited service or roaming, upper layers of the wireless communication device 104 may request that the wireless communication device 104 camp on a requested PLMN 122 (e.g., a selected PLMN or an equivalent PLMN). The wireless communication device 104 may perform a power scan and acquire system information from one or more frequencies.

The wireless communication device 104 may discover 204 a cell 108 in a requested PLMN 122. For example, the wireless communication device 104 may decode a PLMN ID acquired from the system information. The PLMN ID may identify the PLMN 106 of the cell 108. The wireless communication device 104 may discover 204 that the cell 108 is in a requested PLMN 122 by evaluating whether the PLMN 106 of a discovered cell 108 matches the requested PLMN 122.

The wireless communication device 104 may determine 206 that cell selection criteria 126 for the cell 108 is not met. The cell selection criteria 126 may indicate whether a cell 108 is strong enough for the wireless communication device 104 to camp on. For a GSM network, the cell selection criteria 126 may be based on a C1 parameter that is determined for the cell 108. If the C1 parameter is greater than zero, then the cell selection criteria 126 is met. If the C1 parameter is less than or equal to zero, then the cell selection criteria 126 is not met. If the cell selection criteria 126 is not met, then the wireless communication device 104 will not camp on that cell 108 even though the PLMN 106 of the cell 108 matches a requested PLMN 122.

The wireless communication device 104 may add 208 an absolute radio-frequency channel number (ARFCN) 110 of the cell 108 to a monitored list 120. The ARFCN 110 may identify the cell 108. For example, the ARFCN 110 may define a pair of radio frequency (RF) channel frequencies for the downlink 112 and uplink 114 associated with the cell 108.

The wireless communication device 104 may monitor 210 cells 108 in the monitored list 120 more frequently than cells 108 not in the monitored list 120. For example, the wireless communication device 104 may monitor 210 the frequencies associated with the ARFCNs 110 included in the monitored list 120. If the wireless communication device 104 is out of service, the wireless communication device 104 may monitor 210 the ARFCNs 110 in the monitored list 120 at a regular but faster rate than attempts to search ARFCNs 110 in in the monitored list 120 for service.

If the wireless communication device 104 has limited service or is roaming, then the wireless communication device 104 may monitor 210 the cells 108 in the monitored list 120 after the wireless communication device 104 wakes up and decodes a page. For example, while the wireless communication device 104 has limited service or is roaming, the wireless communication device 104 may be camped on a cell 108 that is not in a requested PLMN 122. The wireless communication device 104 may enter an idle mode between paging cycles. The wireless communication device 104 may wake up and decode a page from the cell 108. After waking up and decoding the page, the wireless communication device 104 may monitor 210 the cells 108 in the monitored list 120.

If the wireless communication device 104 finds a cell 108 that meets the cell selection criteria 126, (e.g., C1>0), then the wireless communication device 104 may camp on the cell 108 and perform registration, if necessary, with the network. The wireless communication device 104 may then enter a normal service state.

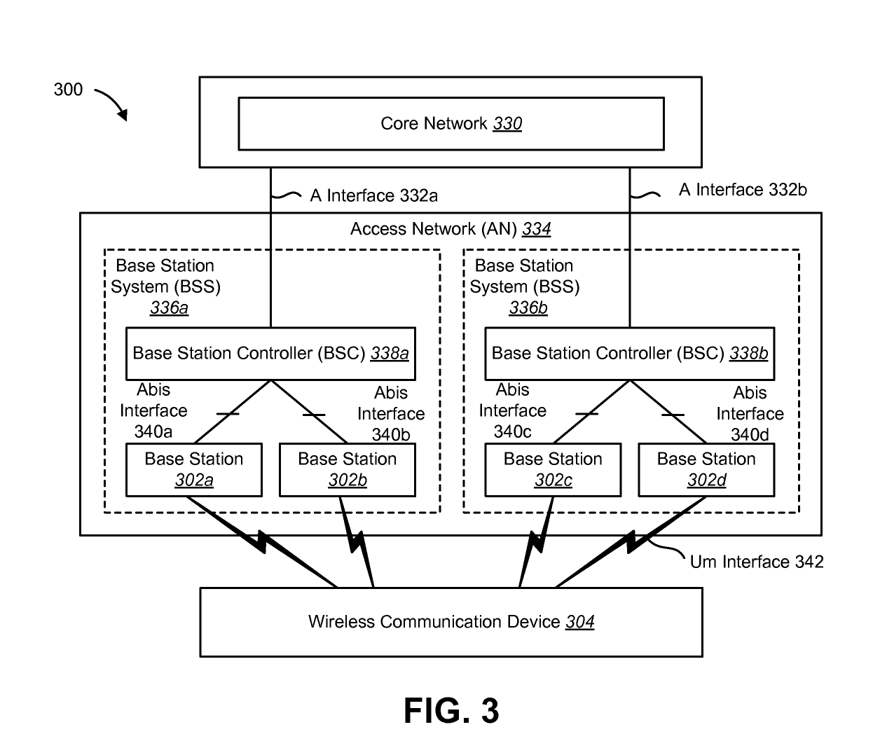

FIG. 3 is a block diagram illustrating a radio network 300 operating according to embodiments of the present invention. The radio network 300 may operate according to Global System for Mobile Communications (GSM) standards and may be referred to as a GSM network. A GSM network is a collective term for the base stations 302a-d and the control equipment for the base stations 302a-d (e.g., base station controllers (BSCs) 338a-b) the GSM network may contain, which make up the access network (AN) 334. The GSM network provides an air interface access method for the wireless communication device 304. Connectivity is provided between the wireless communication device 304 and the core network 330 by the GSM network. The access network (AN) 334 may transport data packets between multiple wireless communication devices 304.

The GSM network is connected internally or externally to other functional entities by various interfaces (e.g., an A interface 332a-b, an Abis interface 340a-d, and a Um interface 342). The GSM network is attached to a core network 330 via an external interface (e.g., an A interface 332a-b). The base station controllers (BSCs) 338a-b support this interface. In addition, the base station controllers (BSCs) 338a-b manage a set of base stations 302a-d through Abis interfaces 340a-d. A base station controller (BSC) 338a and the managed base stations 302a-b form a base station system (BSS) 336a. A base station controller (BSC) 338b and the managed base stations 302c-d form a base station system (BSS) 336b. The Um interface 342 connects a base station 302 with a wireless communication device 304, while the Abis interface 340 is an internal interface connecting the base station controller (BSC) 338 with the base station 302.

The radio network 300 may be further connected to additional networks outside the radio network 300, such as a corporate intranet, the Internet, or a conventional public switched telephone network. The radio network 300 may transport data packets between each wireless communication device 304 and such outside networks.

GSM is a widespread standard in cellular, wireless communication. GSM is relatively efficient for standard voice services. However, high-fidelity audio and data services may require higher data throughput rates than that for which GSM is optimized. To increase capacity, the General Packet Radio Service (GPRS), EDGE (Enhanced Data rates for GSM Evolution) and UMTS (Universal Mobile Telecommunications System) standards have been adopted in GSM systems. In the GSM/EDGE Radio Access Network (GERAN) specification, GPRS and EGPRS provide data services. The standards for GERAN are maintained by the 3GPP (Third Generation Partnership Project). GERAN is a part of GSM. More specifically, GERAN is the radio part of GSM/EDGE together with the network that joins the base stations 102 (the Ater and Abis interfaces 340) and the base station controllers (A interfaces 332, etc.). GERAN represents the core of a GSM network. It routes phone calls and packet data from and to the PSTN (Public Switched Telephone Network) and Internet to and from remote terminals. GERAN is also a part of combined UMTS/GSM networks.

GSM employs a combination of Time Division Multiple Access (TDMA) and Frequency Division Multiple Access (FDMA) for the purpose of sharing the spectrum resource. GSM networks typically operate in a number of frequency bands. For example, for uplink 114 communication, GSM-900 commonly uses a radio spectrum in the 890-915 megahertz (MHz) bands (Mobile Station to Base Transceiver Station). For downlink 112 communication, GSM-900 uses 935-960 MHz bands (base station 302 to wireless communication device 304). Furthermore, each frequency band is divided into 200 kHz carrier frequencies providing 124 RF channels spaced at 200 kHz. GSM-1900 uses the 1850-1910 MHz bands for the uplink 114 and 1930-1990 MHz bands for the downlink 112 Like GSM-900, FDMA divides the spectrum for both uplink 114 and downlink 112 into 200 kHz-wide carrier frequencies. Similarly, GSM-850 uses the 824-849 MHz bands for the uplink 114 and 869-894 MHz bands for the downlink 112, while GSM-1800 uses the 1710-1785 MHz bands for the uplink 114 and 1805-1880 MHz bands for the downlink 112.

Each channel in GSM is identified by a specific absolute radio frequency channel (ARFCN). For example, ARFCN 1-124 are assigned to the channels of GSM-900, while ARFCN 512-810 are assigned to the channels of GSM-1900. Similarly, ARFCN 128-251 are assigned to the channels of GSM-850, while ARFCN 512-885 are assigned to the channels of GSM-1800. Also, each base station 302 is assigned one or more carrier frequencies. Each carrier frequency is divided into eight time slots (which are labeled as time slots 0 through 7) using TDMA such that eight consecutive time slots form one TDMA frame with a duration of 4.615 milliseconds (ms). A physical channel occupies one time slot within a TDMA frame. Each active wireless communication device 304 or user is assigned one or more time slot indices for the duration of a call. User-specific data for each wireless communication device 304 is sent in the time slot(s) assigned to that wireless communication device 304 and in TDMA frames used for the traffic channels.

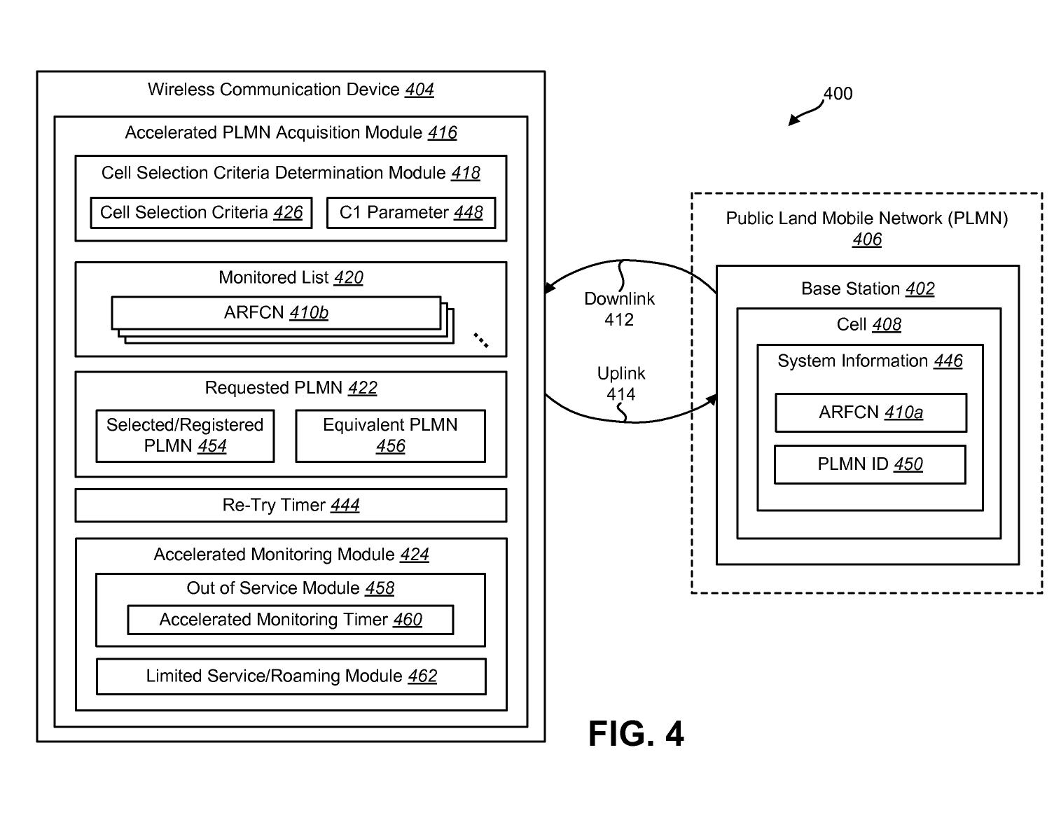

FIG. 4 is a block diagram illustrating an embodiment of a wireless communication system 400 for performing accelerated network acquisition in a GSM network. The wireless communication system 400 may include one or more wireless communication devices 404 and one or more base stations 402. A wireless communication device 404 may communicate with a base station 402 via a downlink 412 and an uplink 414. A base station 402 may be located in a PLMN 406 operating according to GSM standards.

In GSM, when a wireless communication device 404 is experiencing poor coverage, the wireless communication device 404 may be out of service, may have limited service or may be roaming. During poor coverage conditions, the wireless communication device 404 may search for service on a requested PLMN 422. In one embodiment, a requested PLMN 422 may include a selected PLMN 454 or an equivalent PLMN 456. The wireless communication device 404 may include an accelerated PLMN acquisition module 416 to accelerate the acquisition of a requested PLMN 422.

While the wireless communication device 404 is out of service, in limited service or roaming, the wireless communication device 404 may perform a power scan on all supported GSM frequencies to discover cells 408. If the radio signal from a cell 408 is strong enough, the wireless communication device 404 may acquire and decode system information 446 from the cell 408. The system information 446 may be a system information type 3 (SI3) message or a system information type 4 (SI4) message. The system information 446 may include a PLMN ID 450, which identifies the PLMN 406 of the cell 408. Based on the received PLMN ID 450, the wireless communication device 404 may evaluate whether the PLMN 406 of a discovered cell 408 matches a selected PLMN 454 or an equivalent PLMN 456. The system information 446 may also include an ARFCN 410a for the cell 408.

A cell selection criteria determination module 418 may evaluate cell selection criteria 426 for the cell 408. The cell selection criteria 426 may indicate whether the quality of the radio connection to a cell 408 is sufficient for the wireless communication device 404 to camp on the cell 408. In one embodiment, the cell selection criteria 426 may be whether a C1 parameter 448 for a cell 408 is greater than zero (e.g., C1>0). The C1 parameter 448 may also be referred to as a path loss criterion parameter. The cell selection criteria determination module 418 may evaluate the C1 parameter 448 for each discovered cell 408. In one configuration, the C1 parameter 448 may be determined according to Equation (1).

C1=(A−max(B,0)) (1)

In Equation (1), A=RLA_C−RXLEV_ACCESS_MIN, where RLA_C is an average of received signal levels for a cell 408 and RXLEV_ACCESS_MIN is the minimum received signal level at the wireless communication device 404 required for access to the cell 408. Furthermore, in Equation (1), B=MS_TXPWR_MAX_CCH−P, where MS_TXPWR_MAX_CCH is the maximum transmission power level the wireless communication device 404 may use when accessing the cell 408 and P is the maximum radio frequency (RF) output power of the wireless communication device 404. All values in Equation (1) may be expressed in dBm.

If the C1 parameter 448 is greater than zero, then the cell selection criteria 426 is met. If the C1 parameter 448 is less than or equal to zero, then the cell selection criteria 426 is not met.

If the PLMN 406 of a discovered cell 408 matches the selected/registered PLMN 454 or an equivalent PLMN 456, and if that cell 408 meets cell selection criteria 426 (e.g., C1>0), then the wireless communication device 404 may camp on that cell 408. If the cell selection criteria 426 is not met (e.g., C1=<0), then the wireless communication device 404 will not camp on that cell 408 even though the PLMN 406 of the cell 408 matches a requested PLMN 422. The wireless communication device 404 may remain in the same service state as before (e.g., out of service, limited service or roaming). The wireless communication device 404 may start a re-try timer 444. Upon expiration of the re-try timer 444, the wireless communication device 404 may perform another search for service.

When a wireless communication device 404 performs a search procedure while out of service (OOS), in limited service or roaming, if the wireless communication device 404 discovers a cell 408 in a requested PLMN 422, but the cell selection criteria 426 of the cell 408 is not met (e.g., C1=<0), then the wireless communication device 404 may add the ARFCN 410b of the cell 408 to a monitored list 420.

If the monitored list 420 has one or more ARFCNs 410b, then an accelerated monitoring module 424 may keep monitoring those cells 408 in the monitored list 420 more frequently than cells 408 not in the monitored list 420. The accelerated monitoring module 424 may include an out of service module 458 and a limited service/roaming module 462.

If the wireless communication device 404 is out of service, the out of service module 458 may monitor the cells 408 in the monitored list 420 based on an accelerated monitoring timer 460. In one embodiment, the out of service module 458 may monitor the frequencies associated with the ARFCNs 410b included in the monitored list 420. The out of service module 458 may monitor the ARFCNs 410b in the monitored list 420 upon expiration of the accelerated monitoring timer 460, which may have a shorter period than the re-try timer 444. Therefore, the out of service module 458 may monitor cells 408 in the monitored list 420 at a faster rate than attempts to search for service.

If the wireless communication device 404 is in limited service or roaming, the limited service/roaming module 462 may monitor the cells 408 in the monitored list 420 based on paging from a cell 408. While in limited service or roaming, the wireless communication device 404 may be camped on a cell 408. The cell 408 may page the wireless communication device 404 at scheduled times. The wireless communication device 404 may go into idle mode between paging cycles. While in idle mode, the wireless communication device 404 may be in a period of discontinuous reception (DRX) in which the wireless communication device 404 may switch off the receiver to save energy.

At the scheduled paging times, the wireless communication device 404 may wake up (e.g., exit idle mode) to receive and decode the page. Upon waking up and decoding the page, the limited service/roaming module 462 may monitor the cells 408 in the monitored list 420. For example, the limited service/roaming module 462 may monitor the frequencies associated with the ARFCNs 410b included in the monitored list 420. Because the scheduled paging times (e.g., paging cycle) may be shorter than the re-try timer 444, the limited service/roaming module 462 may monitor cells 408 in the monitored list 420 at a faster rate than attempts to search cells other than those in the monitored list for service.

If the out of service module 458 or limited service/roaming module 462 finds a cell 408 in the monitored list 420, then the cell selection criteria determination module 418 may evaluate the cell 408 to determine whether the cell 408 meets the cell selection criteria 426. If the cell 408 meets the cell selection criteria 426, (e.g., C1>0), then the wireless communication device 404 may camp on the cell 408 and perform registration, if necessary, with the network and enter a normal service state.

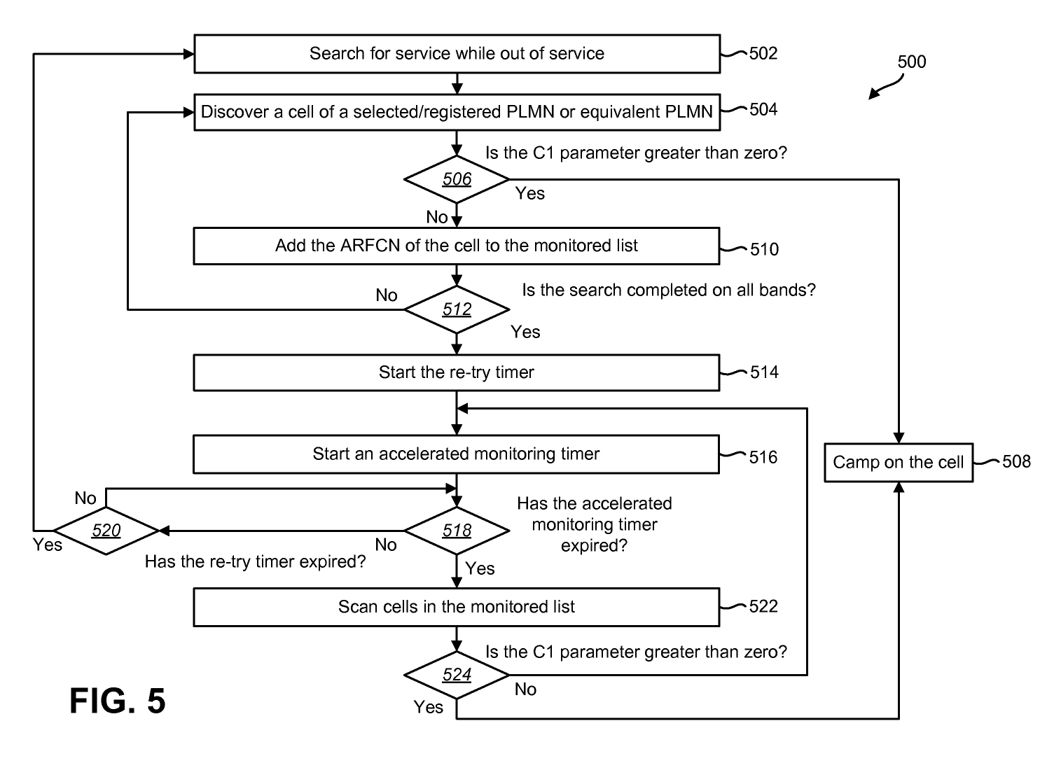

FIG. 5 is a flow diagram of a method 500 for one embodiment of accelerated network acquisition in a GSM network. The method 500 may be performed by a wireless communication device 404. In one configuration, the wireless communication device 404 may include an accelerated PLMN acquisition module 416. The wireless communication device 404 may search 502 for service on a PLMN 406 while out of service. For example, the wireless communication device 404 may be experiencing poor coverage. The wireless communication device 404 may be out of service (e.g., the wireless communication device 404 may not be camped on any cell 408).

The wireless communication device 404 may search 502 for service on a PLMN 406 by performing a power scan. The wireless communication device 404 may scan all the supported GSM frequencies to discover cells 408.

The wireless communication device 404 may discover 504 a cell 408 in a selected/registered PLMN 454 or an equivalent PLMN 456. The radio signal from the cell 408 may be strong enough for the wireless communication device 404 to acquire and decode system information 446 from the cell 408. The system information 446 may include a PLMN ID 450, which identifies the PLMN 406 of the cell 408. Based on the received PLMN ID 450, the wireless communication device 404 may determine that the PLMN 406 of the discovered cell 408 matches a selected/registered PLMN 454 or an equivalent PLMN 456.

The wireless communication device 404 may determine 506 whether a C1 parameter 448 is greater than zero. This may be accomplished as described above in connection with FIG. 4. For example, the wireless communication device 404 may evaluate the C1 parameter 448 for the discovered cell 408 based on Equation (1). If the C1 parameter 448 is greater than zero, then the wireless communication device 404 may camp 508 on the discovered cell 408 and enter a normal service state.

If the wireless communication device 404 determines 506 that the C1 parameter 448 is not greater than zero, then the wireless communication device 404 may add 510 an ARFCN 410 of the discovered cell 408 to a monitored list 420. The ARFCN 410 may identify the cell 408. For example, the ARFCN 410 may define a pair of radio frequency (RF) channel frequencies for the downlink 412 and uplink 414 associated with the cell 408.

The wireless communication device 404 may determine 512 whether the search for service on a cell 408 of a selected/registered PLMN 454 or equivalent PLMN 456 has been completed on all bands (e.g., frequency bands). If the search has not been completed on all bands, then the wireless communication device 404 may continue searching for service to discover 504 a cell 408 of a selected/registered PLMN 454 or equivalent PLMN 456.

If the wireless communication device 404 determines 512 that the search for service is completed on all bands, the wireless communication device 404 may start 514 a re-try timer 444. The re-try timer 444 may indicate when the wireless communication device 404 should perform another search for service.

The wireless communication device 404 may start 516 an accelerated monitoring timer 460. The accelerated monitoring timer 460 may have a shorter time period than the re-try timer 444.

The wireless communication device 404 may determine 518 whether the accelerated monitoring timer 460 has expired. If the accelerated monitoring timer 460 has not expired, then the wireless communication device 404 may determine 520 whether the re-try timer 444 has expired. If the wireless communication device 404 determines 520 that the re-try timer 444 has not expired, the wireless communication device 404 may wait until the expiration of either the accelerated monitoring timer 460 or the re-try timer 444.

If the wireless communication device 404 determines 518 that the accelerated monitoring timer 460 has expired, then the wireless communication device 404 may scan 522 the one or more cells 408 in the monitored list 420. For example, the wireless communication device 404 may scan 522 the frequencies associated with the one or more ARFCNs 410 included in the monitored list 420.

The wireless communication device 404 may determine 524 whether the C1 parameter 448 for the one or more cells 408 in the monitored list 420 is greater than zero. If none of the cells 408 has a C1 parameter 448 that is greater than zero, the wireless communication device 404 may restart 516 the accelerated monitoring timer 460. If the wireless communication device 404 determines 524 that a C1 parameter 448 for a cell 408 in the monitored list 420 is greater than zero, then the wireless communication device 404 may camp 508 on the cell 408. If the wireless communication device 404 determines 524 that more than one cell 408 in the monitored list 420 has a C1 parameter 448 that is greater than zero, then the wireless communication device 404 may select the cell 408 with the highest (e.g., maximum) C1 parameter 448 to camp 508 on.

If the wireless communication device 404 determines 520 that the re-try timer 444 has expired, then the wireless communication device 404 may perform another search 502 for service. The wireless communication device 404 may remain out of service and may search 502 for service on a PLMN 406 by performing another power scan.

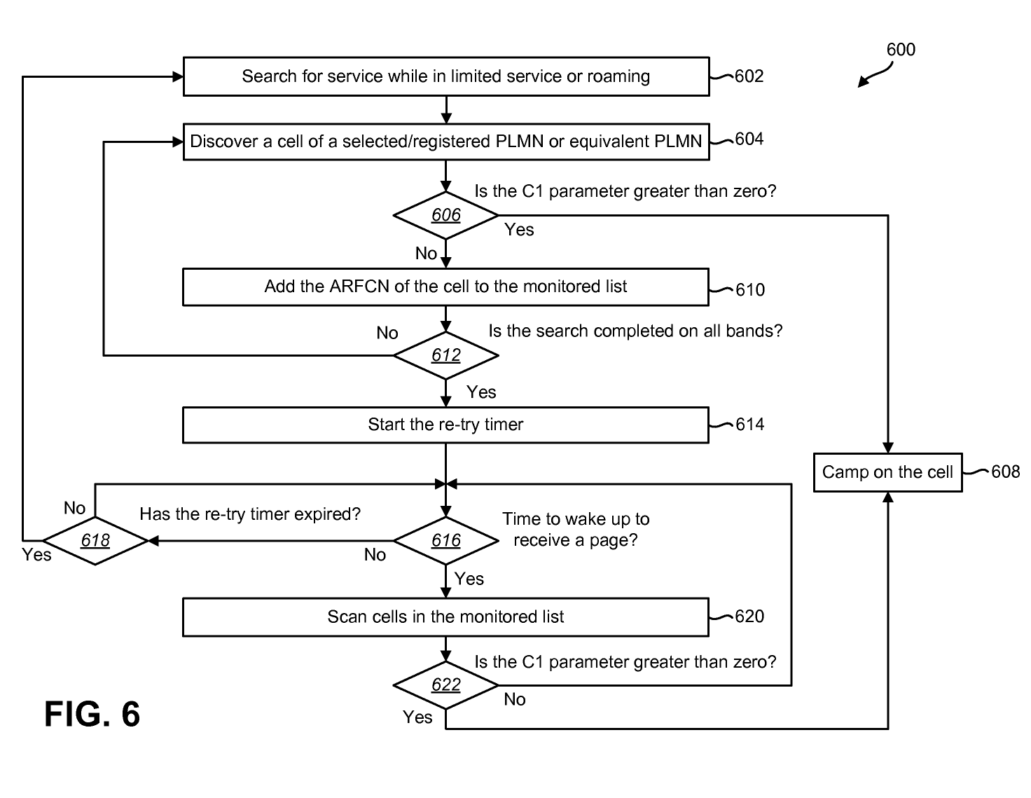

FIG. 6 is a flow diagram of a method 600 for another embodiment of accelerated network acquisition in a GSM network. The method 600 may be performed by a wireless communication device 404. In one configuration, the wireless communication device 404 may include an accelerated PLMN acquisition module 416. The wireless communication device 404 may search 602 for service on a PLMN 406 while in limited service or roaming. For example, the wireless communication device 404 may be experiencing poor coverage and may have limited service or may be roaming. In this case, the wireless communication device 404 may be camped on a cell 408, but the cell 408 may not belong to a selected/registered PLMN 454 or equivalent PLMN 456.

The wireless communication device 404 may search 602 for service on a PLMN 406 by performing a power scan. The wireless communication device 404 may scan all the supported GSM frequencies to discover cells 408.

The wireless communication device 404 may discover 604 a cell 408 of a selected/registered PLMN 454 or an equivalent PLMN 456. This may be accomplished as described above in connection with FIG. 4. For example, the wireless communication device 404 may determine that the PLMN 406 of the discovered cell 408 matches a selected/registered PLMN 454 or an equivalent PLMN 456 based on a received PLMN ID 450.

The wireless communication device 404 may determine 606 whether a C1 parameter 448 is greater than zero. This may be accomplished as described above in connection with FIG. 4. For example, the wireless communication device 404 may evaluate the C1 parameter 448 for the discovered cell 408 based on Equation (1). If the C1 parameter 448 is greater than zero, then the wireless communication device 404 may camp 608 on the discovered cell 408 and enter a normal service state.

If the wireless communication device 404 determines 606 that the C1 parameter 448 is not greater than zero, then the wireless communication device 404 may add 610 an ARFCN 410 of the discovered cell 408 to a monitored list 420. The ARFCN 410 may identify the cell 408. For example, the ARFCN 410 may define a pair of radio frequency (RF) channel frequencies for the downlink 412 and uplink 414 associated with the cell 408.

The wireless communication device 404 may determine 612 whether the search for service on a cell 408 of a selected/registered PLMN 454 or equivalent PLMN 456 has been completed on all bands (e.g., frequency bands). If the search has not been completed on all bands, then the wireless communication device 404 may continue searching for service to discover 604 a cell 408 of a selected/registered PLMN 454 or equivalent PLMN 456.

If the wireless communication device 404 determines 612 that the search for service is completed on all bands, the wireless communication device 404 may start 614 a re-try timer 444. The re-try timer 444 may indicate when the wireless communication device 404 should perform another search for service.

The wireless communication device 404 may determine 616 whether it is time to wake up to receive a page. Because the wireless communication device 404 is in limited service or roaming, the wireless communication device 404 may be camped on a cell 408 that does not belong to a selected/registered PLMN 454 or equivalent PLMN 456. The wireless communication device 404 may determine 616 whether it should wake up to receive a scheduled page from the cell 408. If the wireless communication device 404 determines 616 that it is not time to wake up, then the wireless communication device 404 may determine 618 whether the re-try timer 444 has expired. If the wireless communication device 404 determines 618 that the re-try timer 444 has not expired, the wireless communication device 404 may wait until it is time to wake up to receive a page or the re-try timer 444 expires.

If the wireless communication device 404 determines 616 that it is time to wake up to receive a page, then the wireless communication device 404 may wake up and receive the page from the cell 408. Upon decoding the page, the wireless communication device 404 may scan 620 the one or more cells 408 in the monitored list 420. For example, the wireless communication device 404 may scan 620 the frequencies associated with the one or more ARFCNs 410 included in the monitored list 420.

The wireless communication device 404 may determine 622 whether the C1 parameter 448 for the one or more cells 408 in the monitored list 420 is greater than zero. If none of the one or more cells 408 has a C1 parameter 448 that is greater than zero, the wireless communication device 404 may wait until the next time to wake up to receive the page or the re-try timer 444 expires.

If the wireless communication device 404 determines 622 that a C1 parameter 448 for a cell 408 in the monitored list 420 is greater than zero, then the wireless communication device 404 may camp 608 on the cell 408. If the wireless communication device 404 determines 622 that more than one cell 408 in the monitored list 420 has a C1 parameter 448 that is greater than zero, then the wireless communication device 404 may select the cell 408 with the highest (e.g., maximum) C1 parameter 448 to camp 608 on.

If the wireless communication device 404 determines 618 that the re-try timer 444 has expired, then the wireless communication device 404 may search 602 for service on a selected/registered PLMN 454 or equivalent PLMN 456. The wireless communication device 404 may remain in limited service or roaming and may search 602 for service on a selected/registered PLMN 454 or equivalent PLMN 456 by performing another power scan.

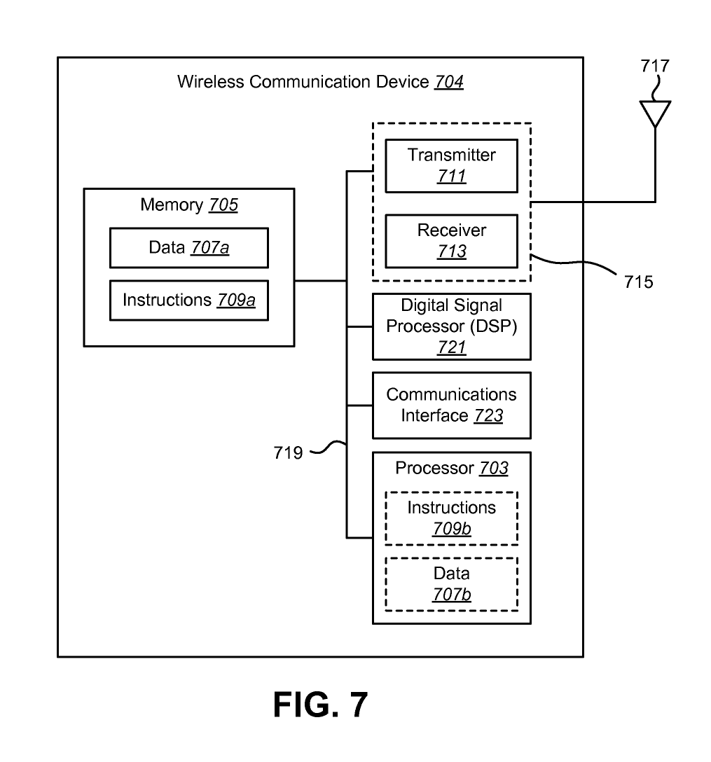

FIG. 7 illustrates certain components that may be included within a wireless communication device 704 according to some embodiments of the present invention. The wireless communication device 704 may be an access terminal, a mobile station, a user equipment (UE), etc. For example, the wireless communication device 704 may be the wireless communication device 104 of FIG. 1.

The wireless communication device 704 includes a processor 703. The processor 703 may be a general purpose single- or multi-chip microprocessor (e.g., an ARM), a special purpose microprocessor (e.g., a digital signal processor (DSP)), a microcontroller, a programmable gate array, etc. The processor 703 may be referred to as a central processing unit (CPU). Although just a single processor 703 is shown in the wireless communication device 704 of FIG. 7, in an alternative configuration, a combination of processors (e.g., an ARM and DSP) could be used.

The wireless communication device 704 also includes memory 705. The memory 705 may be any electronic component capable of storing electronic information. The memory 705 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 707a and instructions 709a may be stored in the memory 705. The instructions 709a may be executable by the processor 703 to implement the methods disclosed herein. Executing the instructions 709a may involve the use of the data 707a that is stored in the memory 705. When the processor 703 executes the instructions 709, various portions of the instructions 709b may be loaded onto the processor 703, and various pieces of data 707b may be loaded onto the processor 703.

The wireless communication device 704 may also include a transmitter 711 and a receiver 713 to allow transmission and reception of signals to and from the wireless communication device 704 via an antenna 717. The transmitter 711 and receiver 713 may be collectively referred to as a transceiver 715. The wireless communication device 704 may also include (not shown) multiple transmitters, additional antennas, multiple receivers and/or multiple transceivers.

The wireless communication device 704 may include a digital signal processor (DSP) 721. The wireless communication device 704 may also include a communications interface 723. The communications interface 723 may allow a user to interact with the wireless communication device 704.

The various components of the wireless communication device 704 may be coupled together by one or more buses, which may include a power bus, a control signal bus, a status signal bus, a data bus, etc. For the sake of clarity, the various buses are illustrated in FIG. 7 as a bus system 719.

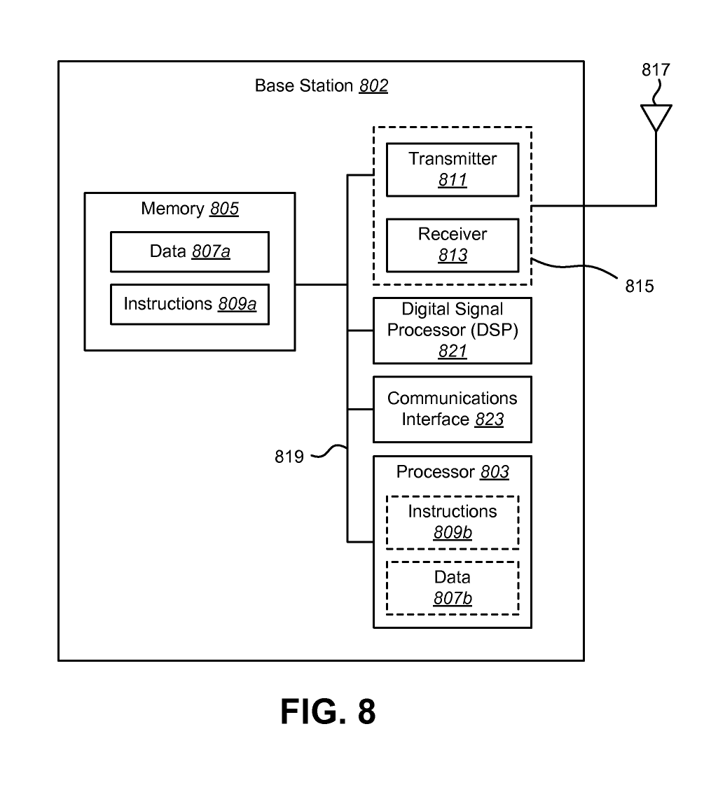

FIG. 8 illustrates certain components that may be included within a base station 802 according to some embodiments of the present invention. A base station 802 may also be referred to as, and may include some or all of the functionality of, an access point, a broadcast transmitter, a NodeB, an evolved NodeB, etc. For example, the base station 802 may be the base station 102 of FIG. 1.

The base station 802 includes a processor 803. The processor 803 may be a general purpose single- or multi-chip microprocessor (e.g., an ARM), a special purpose microprocessor (e.g., a digital signal processor (DSP)), a microcontroller, a programmable gate array, etc. The processor 803 may be referred to as a central processing unit (CPU). Although just a single processor 803 is shown in the base station 802 of FIG. 8, in an alternative configuration, a combination of processors (e.g., an ARM and DSP) could be used.

The base station 802 also includes memory 805. The memory 805 may be any electronic component capable of storing electronic information. The memory 805 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 807a and instructions 809a may be stored in the memory 805. The instructions 809a may be executable by the processor 803 to implement the methods disclosed herein. Executing the instructions 809a may involve the use of the data 807a that is stored in the memory 805. When the processor 803 executes the instructions 809a, various portions of the instructions 809b may be loaded onto the processor 803, and various pieces of data 807b may be loaded onto the processor 803.

The base station 802 may also include a transmitter 811 and a receiver 813 to allow transmission and reception of signals to and from the base station 802. The transmitter 811 and receiver 813 may be collectively referred to as a transceiver 815. An antenna 817 may be electrically coupled to the transceiver 815. The base station 802 may also include (not shown) multiple transmitters, multiple receivers, multiple transceivers and/or additional antennas.

The base station 802 may include a digital signal processor (DSP) 821. The base station 802 may also include a communications interface 823. The communications interface 823 may allow a user to interact with the base station 802.

The various components of the base station 802 may be coupled together by one or more buses, which may include a power bus, a control signal bus, a status signal bus, a data bus, etc. For the sake of clarity, the various buses are illustrated in FIG. 8 as a bus system 819.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 2, FIG. 5 and FIG. 6, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

We claim:

1. A method for wireless communication by a wireless communication device, comprising:
searching for service on a public land mobile network (PLMN);
discovering a cell of a requested PLMN;
determining that cell selection criteria for the cell is not met;
adding the cell to a monitored list; and
monitoring cells in the monitored list more frequently than cells not in the monitored list.

2. The method of claim 1, wherein the wireless communication device is out-of-service (OOS), in limited service or roaming.

3. The method of claim 1, wherein monitoring cells in the monitored list more frequently than cells not in the monitored list comprises monitoring the cells in the monitored list upon waking up and decoding a page.

4. The method of claim 1, further comprising monitoring cells in the monitored list at regular intervals.

5. The method of claim 1, further comprising repeatedly monitoring cells in the monitored list at a faster rate than cells not in the monitored list.

6. The method of claim 1, further comprising camping on a cell when a cell is found that meets the cell selection criteria.

7. The method of claim 1, wherein the requested PLMN is one of a selected PLMN, a registered PLMN or an equivalent PLMN, wherein the selected PLMN or the registered PLMN are a home PLMN for the wireless communication device, and wherein the equivalent PLMN is treated as a home PLMN for the wireless communication device.

8. The method of claim 1, wherein determining that cell selection criteria for the cell is not met comprises evaluating a C1 parameter for the cell, wherein if the C1 parameter is greater than zero, then the cell selection criteria is met, and wherein if the C1 parameter is less than or equal to zero, then the cell selection criteria is not met.

9. The method of claim 8, wherein the C1 parameter is determined based on received signal levels for the cell, a minimum received signal level at the wireless communication device required for access to the cell, a maximum transmission power level the wireless communication device may use when accessing the cell and a maximum radio frequency output power of the wireless communication device.

10. An apparatus for wireless communication, comprising:
a processor;
memory in electronic communication with the processor; and
instructions stored in the memory, the instructions being executable by the processor to:
search for service on a public land mobile network (PLMN);
discover a cell of a requested PLMN;
determine that cell selection criteria for the cell is not met;
add the cell to a monitored list; and
monitor cells in the monitored list more frequently than cells not in the monitored list.

11. The apparatus of claim 10, wherein the apparatus is out-of-service (OOS), in limited service or roaming.

12. The apparatus of claim 10, wherein the instructions executable to monitor cells in the monitored list more frequently than cells not in the monitored list comprise instructions executable to monitor the cells in the monitored list upon waking up and decoding a page.

13. The apparatus of claim 10, further comprising instructions executable to monitor cells in the monitored list at regular intervals.

14. The apparatus of claim 10, further comprising instructions executable to repeatedly monitor cells in the monitored list at a faster rate than cells not in the monitored list.

15. The apparatus of claim 10, wherein the instructions are further executable to camp on a cell when a cell is found that meets the cell selection criteria.

16. The apparatus of claim 10, wherein the requested PLMN is one of a selected PLMN, a registered PLMN or an equivalent PLMN, wherein the selected PLMN and the registered PLMN are a home PLMN for the wireless communication device, and wherein the equivalent PLMN is treated as a home PLMN for the wireless communication device.

17. The apparatus of claim 10, wherein the instructions executable to determine that cell selection criteria for the cell is not met comprise instructions executable to evaluate a C1 parameter for the cell, wherein if the C1 parameter is greater than zero, then the cell selection criteria is met, and wherein if the C1 parameter is less than or equal to zero, then the cell selection criteria is not met.

18. The apparatus of claim 17, wherein the C1 parameter is determined based on received signal levels for the cell, a minimum received signal level at the wireless communication device required for access to the cell, a maximum transmission power level the wireless communication device may use when accessing the cell and a maximum radio frequency output power of the wireless communication device.

19. A wireless device comprising:
means for searching for service on a public land mobile network (PLMN);
means for discovering a cell of a requested PLMN;
means for determining that cell selection criteria for the cell is not met;
means for adding the cell to a monitored list; and
means for monitoring cells in the monitored list more frequently than cells not in the monitored list.

20. The wireless device of claim 19, wherein the wireless is out-of-service (OOS), in limited service or roaming.

21. The wireless device of claim 19, wherein the means for monitoring cells in the monitored list more frequently than cells not in the monitored list comprise means for monitoring the cells in the monitored list upon waking up and decoding a page.

22. The wireless device of claim 19, further comprising means for repeatedly monitoring cells in the monitored list at a faster rate than cells not in the monitored list.

23. The wireless device of claim 19, further comprising means for camping on a cell when a cell is found that meets the cell selection criteria.

24. The wireless device of claim 19, wherein the means for determining that cell selection criteria for the cell is not met comprise means for evaluating a C1 parameter for the cell, wherein if the C1 parameter is greater than zero, then the cell selection criteria is met, and wherein if the C1 parameter is less than or equal to zero, then the cell selection criteria is not met.

25. A computer-program product for wireless communications, the computer-program product comprising a non-transitory computer-readable medium having instructions thereon, the instructions comprising:
code for causing a wireless communication device to search for service on a public land mobile network (PLMN);
code for causing the wireless communication device to discover a cell of a requested PLMN;
code for causing the wireless communication device to determine that cell selection criteria for the cell is not met;
code for causing the wireless communication device to add the cell to a monitored list; and
code for causing the wireless communication device to monitor cells in the monitored list more frequently than cells not in the monitored list.

26. The computer-program product of claim 25, wherein the wireless communication device is out-of-service (OOS), in limited service or roaming.

27. The computer-program product of claim 25, wherein the code for causing the wireless communication device to monitor cells in the monitored list more frequently than cells not in the monitored list comprises code for causing the wireless communication device to monitor the cells in the monitored list upon waking up and decoding a page.

28. The computer-program product of claim 25, further comprising code for causing the wireless communication device to repeatedly monitor cells in the monitored list at a faster rate than cells not in the monitored list.

29. The computer-program product of claim 25, further comprising code for causing the wireless communication device to camp on a cell when a cell is found that meets the cell selection criteria.

30. The computer-program product of claim 25, wherein the code for causing the wireless communication device to determine that cell selection criteria for the cell is not met comprises code for causing the wireless communication device to evaluate a C1 parameter for the cell, wherein if the C1 parameter is greater than zero, then the cell selection criteria is met, and wherein if the C1 parameter is less than or equal to zero, then the cell selection criteria is not met.
